(19) United States
(12) Patent Application Publication
(10) Pub. No.: US 2013/0173196 A1
(43) Pub. Date: Jul. 4, 2013

(54) PHYSICAL QUANTITY SENSOR

(71) Applicant: Yoichi Nagata, Saitama (JP)

(72) Inventor: Yoichi Nagata, Saitama (JP)

(73) Assignees: CITIZEN FINETECH MIYOTA CO., LTD., Nagano (JP); CITIZEN HOLDINGS CO., LTD., Tokyo (JP)

(21) Appl. No.: 13/824,068

(22) PCT Filed: Sep. 30, 2011
(86) PCT No.: PCT/JP2011/073155

§ 371 Date: Mar. 15, 2013

(30) Foreign Application Priority Data
Sep. 30, 2010 (JP) 2010-221187

(51) Int. Cl. G06F 17/00

(52) U.S. Cl. CPC G06F 17/00
USPC 702/86; 702/189

(57) ABSTRACT

The invention is directed to the provision of a physical quantity sensor that can suppress noise caused by external vibrations, while also suppressing variations in output signal caused by variations in reference voltage. The physical quantity sensor includes an oscillator which converts an externally applied physical quantity into an electrical signal, a reference signal generating circuit which outputs a reference signal; an oscillator circuit which causes the oscillator to oscillate by applying an oscillator signal produced based on the reference signal, and a detector circuit which detects an output signal of the oscillator by multiplying the output signal by the oscillator signal and dividing the reference signal.

### TECHNICAL FIELD

The present invention relates to a physical quantity sensor and a multiplier/divider circuit, and more specifically to the configuration of a detector circuit for use in a physical quantity sensor.

### BACKGROUND

As a physical quantity sensor exemplified by a oscillator-type angular velocity sensor, a physical quantity sensor which detects by using a selector circuit constructed from a switch is commonly employed because the configuration of the detector circuit is simple (for example, patent document 1). It is also known to provide a detector circuit that uses a Gilbert multiplier circuit (for example, patent document 2).
Patent document 1: Japanese Unexamined Patent Publication No. 2009-229447 (pp. 8-10, FIGS. 1 and 3)
Patent document 2: Japanese Unexamined Patent Publication No. 2005-191840 (page 9, FIG. 4)

### SUMMARY

However, in the configuration disclosed in patent document 1, if mechanical vibrations, etc., are externally applied to the physical quantity sensor, its internal vibrating member vibrates, and unwanted noise is superimposed on the detected signal. In particular, if noise having a frequency equal to an odd multiple of the frequency to be detected has been superimposed on the detected signal, the noise component cannot be removed by the detector circuit but is mixed into the output signal. This problem is inherent in the operating principle of the detection performed by switching. One possible method to avoid this problem is to multiply signals of the same frequency in the analog domain.

A Gilbert multiplier circuit is an example of the circuit element commonly used as the multiplier circuit. For example, if the detection using the Gilbert multiplier circuit disclosed in patent document 2 is to be applied to a physical quantity sensor, a constant-amplitude signal having the same frequency as the detected signal has to be provided in order to achieve the detection by multiplication. In a oscillator-type physical quantity sensor, AGC control controls the excitation level of the oscillator to a constant level based on a reference signal generated using a constant-voltage circuit or the like. Therefore, an oscillator signal controlled by the AGC control might be used as the multiplying signal. However, in actuality, the reference signal changes with changes in temperature.

Further, since the detected signal is proportional not only to the angular velocity but also to the excitation level of the oscillator, if the detected signal and the oscillator signal are simply multiplied together, a component equivalent to the square of the reference signal will appear in the detection signal, causing a significant error in the detection signal.

This presents an obstacle from achieving increased accuracy over a wide operating temperature range which has come to be required of physical quantity sensors in recent years.

It is an object of the present invention to provide a physical quantity sensor and a multiplier/divider circuit that can solve the above problem.

It is also an object of the present invention to provide a physical quantity sensor and a multiplier/divider circuit that can suppress noise caused by external vibrations, while also suppressing variations in output signal caused by variations in reference voltage.

The physical quantity sensor according to the invention includes an oscillator which converts an externally applied physical quantity into an electrical signal, a reference signal generating circuit which outputs a reference signal, an oscillator circuit which causes the oscillator to oscillate by applying an oscillator signal produced based on the reference signal, and a detector circuit which detects an output signal of the oscillator by performing a multiplication of the output signal by the oscillator signal and a division by the reference signal.

More specifically, the physical quantity sensor includes an oscillator which converts an externally applied physical quantity into an electrical signal, a reference signal generating circuit which outputs a reference signal, an oscillator circuit which causes the oscillator to oscillate based on the reference signal, and a detector circuit which detects an output signal of the oscillator based on an oscillator signal produced by the oscillator circuit, wherein the detector circuit includes an adder circuit which adds the reference signal to either one of the oscillator signal and the output signal, and a Gilbert multiplier circuit which multiplies the oscillator signal or the output signal, whichever signal to which the reference signal has been added, by the one of the other signals.

With the above configuration, it becomes possible to achieve a high-accuracy physical quantity sensor that can suppress the effects of variations in reference signal, while performing detection using the multiplier circuit in order to suppress noise caused by external vibrations.

Preferably, in the physical quantity sensor, the detector circuit includes a multiplier core comprising a first differential transistor pair constructed from a pair of emitter-coupled bipolar transistors and a second differential transistor pair constructed from a pair of emitter-coupled bipolar transistors, a linearizing transistor pair constructed from a pair of collector-coupled bipolar transistors, and an adder circuit which adds the reference signal to either one of the oscillator signal and the output signal, wherein a base of one of the bipolar transistors in the first differential transistor pair and a base of one of the bipolar transistors in the second differential transistor pair are coupled together and connected to an emitter of one of the bipolar transistors in the linearizing transistor pair, and wherein a base of the other one of the bipolar transistors in the first differential transistor pair and a base of the other one of the bipolar transistors in the second differential transistor pair are coupled together and connected to an emitter of the other one of the bipolar transistors in the linearizing transistor pair, and wherein either one of the oscillator signal and wherein the output signal is input to the coupled emitters of the first and second differential transistor pairs, and wherein the other one of the oscillator signal and the output signal is input to the emitters of the linearizing transistor pair.

Preferably, in the physical quantity sensor, the detector circuit further includes a converter circuit which converts the oscillator signal, the output signal, and the reference signal respectively from voltage signals into current signals.

Preferably, in the physical quantity sensor, the adder circuit adds either one of the oscillator signal and the output signal respectively converted into the current signals to the reference signal converted into the current signal. With this configuration, the adder circuit that performs a highly accurate addition operation can be implemented by suitably wiring the connections.

Preferably, in the physical quantity sensor, the adder circuit adds either one of the oscillator signal and the output signal to the reference signal in the form of voltage signals. With this configuration, since the addition can be performed in the form of voltage signals, i.e., in the form of internal signals in the usual integrated circuit, an efficient configuration can be achieved in accordance with the peripheral circuit configuration of the detector circuit.

According to the configuration of the present invention, since variations in the reference signal during product detection can be compensated for, it becomes possible to achieve a high-accuracy physical quantity sensor that is robust against noise caused by external vibrations and that can reduce the effects that variations in the reference voltage may have on the output signal.

The multiplier/divider circuit according to the invention includes a multiplier core comprising a first differential transistor pair constructed from a pair of emitter-coupled bipolar transistors and a second differential transistor pair constructed from a pair of emitter-coupled bipolar transistors, a linearizing transistor pair constructed from a pair of collector-coupled bipolar transistors, and an adder circuit which adds a third input signal to either one of first and second input signals, wherein a base of one of the bipolar transistors in the first differential transistor pair and a base of one of the bipolar transistors in the second differential transistor pair are coupled together and connected to an emitter of one of the bipolar transistors in the linearizing transistor pair, and wherein a base of the other one of the bipolar transistors in the first differential transistor pair and a base of the other one of the bipolar transistors in the second differential transistor pair are coupled together and connected to an emitter of the other one of the bipolar transistors in the linearizing transistor pair, and wherein the first input signal and the second input signal are input to the coupled emitters of the first and second differential transistor pairs, while the third input signal is input to the emitters of the linearizing transistor pair, and wherein a signal obtained by multiplying the first and second input signals together and dividing by the third input signal is output.

### BRIEF DESCRIPTION OF THE DRAWINGS

FIG. 1 is a block diagram for explaining the entire configuration of a physical quantity sensor.

FIG. 2 is a circuit diagram for explaining a detector circuit used in the physical quantity sensor.

FIG. 3 is a circuit diagram for explaining a V-I converter circuit used in the physical quantity sensor.

FIGS. 4(a) to 4(c) are diagrams showing examples of waveforms in the physical quantity sensor.

FIGS. 5(a) and 5(h) are diagrams for explaining a multiplier/divider circuit 140.

### DESCRIPTION OF EMBODIMENTS

A physical quantity sensor will be described below with reference to the drawings. It will, however, be noted that the technical scope of the present invention is not limited to any specific embodiment described herein but extends to the inventions described in the appended claims and their equivalents.

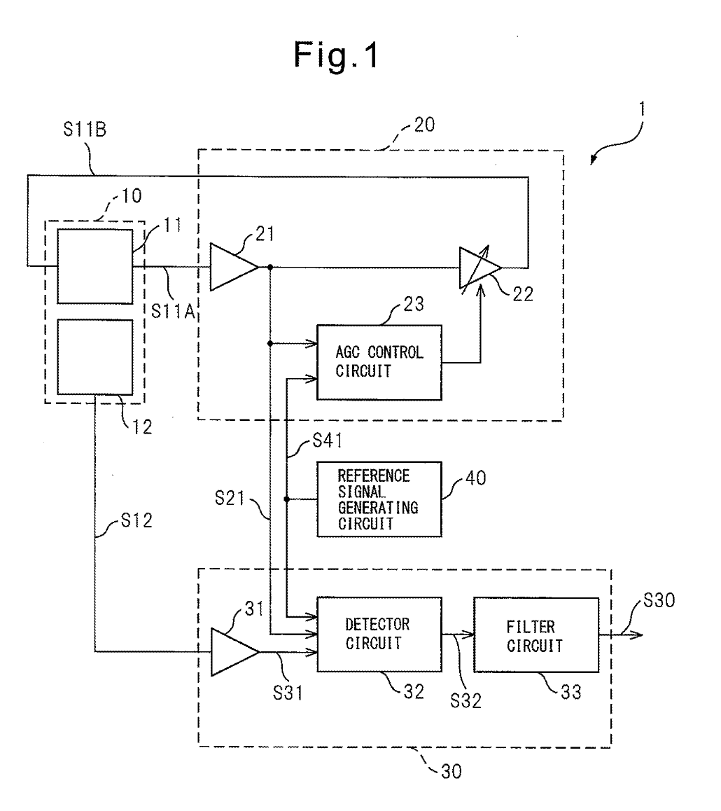

FIG. 1 is a block diagram for explaining the entire configuration of the physical quantity sensor 1.

The physical quantity sensor 1 is a oscillator-type angular velocity sensor which comprises a sensor device 10, an oscillator circuit 20, a detection circuit 30, and a reference signal generating circuit 40.

The sensor device 10 is a gyro oscillator for detecting rotational angular velocity, which is constructed by arranging metal electrodes on a surface of a piezoelectric material formed in the shape of a tuning fork, and includes a driving part 11 and a detection part 12. The sensor device 10 is driven to oscillate by the oscillator circuit 20. When the sensor device 10 experiences a rotational angular velocity while in oscillation, a minuscule AC signal is output from the detection part 12 as a sensor device output S12. A vibrating device having some other suitable shape, for example, a vibrating device having three vibrating prongs, may be used as the sensor device 10.

The reference signal generating circuit 40 is a circuit that generates a reference signal for an AGC control circuit which will be described later. The reference signal generating circuit 40 includes a constant-voltage circuit, and generates a reference signal S41 which is a voltage maintained substantially constant despite variations in ambient temperature or in supply voltage.

The oscillator circuit 20 is a circuit having the so-called AGC function and, together with a monitor circuit 21 and a variable gain amplifier 22, forms an oscillation loop with respect to the sensor device 10. The oscillator circuit 20 includes the AGC control circuit 32 which has the function of controlling the gain of the variable gain amplifier 22 so that the rms value of the excitation current of the sensor device 10 becomes equal to the reference signal S41. The excitation current of the sensor device 10 is converted in advance into a voltage signal by the monitor circuit 21.

In the above configuration, the oscillation of the sensor device 10 is controlled by the AGC control circuit 23, and the monitor circuit 21 outputs an oscillator signal S21, i.e., an AC signal, whose amplitude is based on the reference signal S41. The oscillator signal S21 is also used as a signal for multiplication in the detection circuit 30 as will be described hereinafter.

The detection circuit 30 comprises an amplifier circuit 31 for amplifying the sensor device output S12 which is the output signal from the detection part 12 of the sensor device 10, a detector circuit 32 for detecting an angular velocity signal component contained in the amplified signal S31 output from the amplifier circuit 31, and a filter circuit 32 for amplifying and smoothing the detected signal S32 output from the detector circuit 32 and for outputting the amplified and smoothed signal as a physical quantity sensor output S30. The detector circuit 32 is an operational circuit that computes the product of the output signal of the amplifier circuit 31 and the oscillator signal S21 in the analog domain. The oscillator circuit 20 and the detection circuit 30 are implemented as an integrated circuit formed on a single semiconductor device and are operated by applying supply voltages V+ and V−. Alternatively, the oscillator circuit 20 and the detection circuit 30 may be implemented on different semiconductor devices.

The product detection will be briefly described below.

Generally, when sine waves having the same phase but different amplitudes A and B, respectively, are multiplied together, the following equation (1) results.

(A·sin θ)·(B·sin θ)=A·B·(1−cos 2θ)/2 (1)

If it is assumed that 0 represents the phase angle (θ=ω·t) proportional to time, it can be seen from the properties of trigonometric functions that two components, i.e., a DC signal and a signal at twice the frequency of the original signal, are obtained from the multiplication. When this signal is passed through a filter that allows only low frequencies to pass through, the component of (−A·B·cos 2θ/2) is cut off, and a DC signal of magnitude (A·B/2) is obtained. The oscillator signal S21 and the amplified signal S31 are of the same frequency. If signals in which A is substantially constant and B is proportional to the applied rotational angular velocity are chosen, and an operation such as expressed by the above equation is applied, a signal proportional to the rotational angular velocity is obtained. Based on this principle, the detection circuit 30 described hereinafter performs the detection.

The oscillator signal S21 for causing the sensor device 10 to oscillate, the amplified signal S31 output from the sensor device 10, which is proportional to the rotational angular velocity, and the reference signal S41 output from the reference signal generating circuit 40, respectively, are defined as follows:

S21=A·sin ωt

S31=B·sin ωt

S41=Vref

Vref is the reference voltage value. Since the amplitude of the oscillator signal S21 is controlled by the AGC control circuit 23 at a constant level based on the reference signal S41, “A” is a function of Vref. Further, since the amplified signal S31 is output from the sensor device 10 whose oscillation is controlled based on the oscillator signal S21, “B” is also a function of Vref. Accordingly, when the product detection is performed by simply using the oscillator signal S21 and the amplified signal S31, the DC signal (A·B/2) proportional to the detected rotational angular velocity is proportional to the square of Vref, as can be seen from the above equation (1).

The reference signal S41 is not necessarily perfectly constant, but varies, though slightly, with temperature, etc., even if a temperature compensation circuit or the like is provided. There can also occur cases where noise, etc., are superimposed on the reference signal S41. If the reference signal S41 varies, or if noise is superimposed on the reference signal S41, the DC signal proportional to the detected rotational angular velocity varies appreciably as the square of the noise or the variation of the reference signal S41. Such variation presents an obstacle to achieving increased accuracy over the wide operating temperature range of the physical quantity sensor.

In view of this, the detector circuit 32 in the physical quantity sensor is configured to perform the product detection based on the following equation (2), as will be described in detail later.

(A·sin θ)·(B·sin θ)/Vref=A·B·(1−cos 2θ)/(2−Vref) (2)

In the above equation (2), the DC signal proportional to the detected rotational angular velocity corresponds to A·B·(2·Vref), that is, varies in proportion to Vref, not as the square of Vref. Accordingly, if the reference signal S41 varies, or if noise is superimposed on it, the output of the physical quantity sensor does not appreciably vary (refer to equation (8) to be given later).

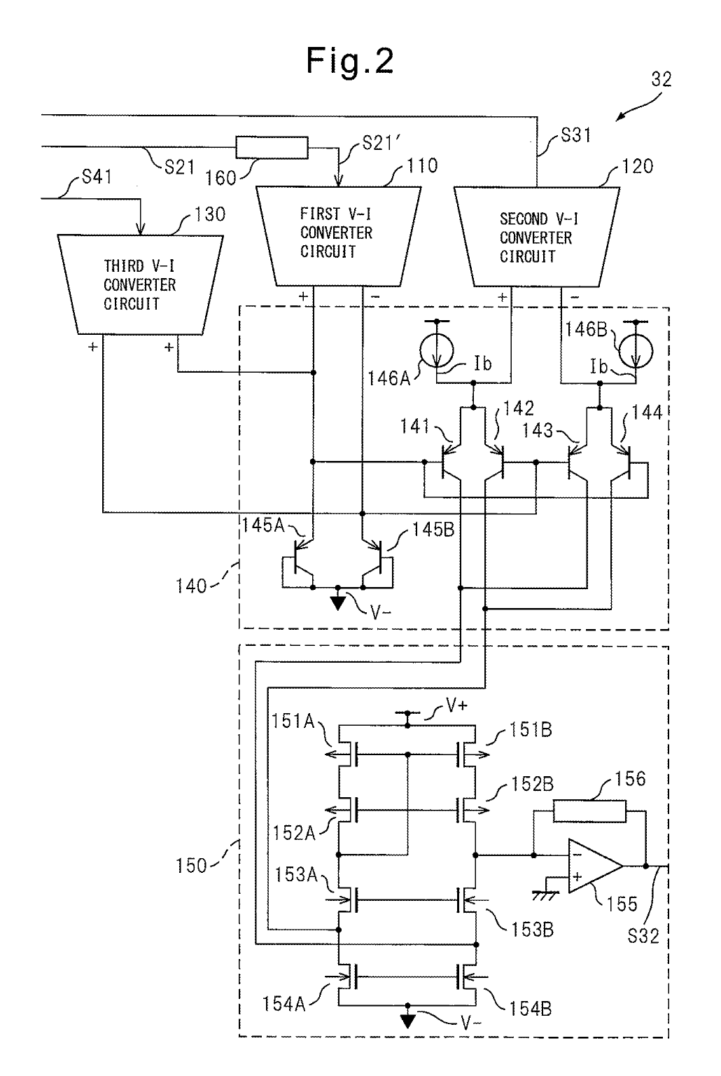

FIG. 2 is a circuit diagram for explaining the detector circuit 32 used in the physical quantity sensor.

The detector circuit 32 comprises first to third V-I converter circuits 110, 120, and 130, a multiplier/divider circuit 140, an I-V converter circuit 150, and a phase shift circuit 160.

In the detector circuit 32, the first V-I converter circuit 110 and the second V-I converter circuit 120 respectively convert the oscillator signal S21 and the amplified signal S31 into current signals. A circuit configuration that provide a differential output is employed for these two V-I converter circuits.

The oscillator signal S21 is input to the first V-I converter circuit 110 via the phase shift circuit 160. This is to achieve phase alignment between the signals to be multiplied together as previously shown by the product detection equation. The phase-adjusted signal is designated as the oscillator signal S21′.

In the detector circuit 32, the third V-I converter circuit 130 converts the reference signal S41 into a current signal. The third V-I converter circuit 130 is configured to output equal output currents from two terminals. The configuration of each V-I converter circuit will be described in detail later.

The multiplier/divider circuit 140 multiplies the input current signals and produces a current output as the result. It can be said that the multiplier/divider circuit 140 is a so-called Gilbert multiplier circuit constructed from a plurality of bipolar transistors. The multiplier/divider circuit 140 has a differential input, differential-output configuration.

The configuration of the multiplier/divider circuit 140 will be described.

The multiplier/divider circuit 140 comprises bipolar transistors 141 to 144, 145A, and 145B, and bias current sources 146A and 146B. All of these transistors are PNP transistors.

The multiplier/divider circuit 140 includes a multiplier core comprising a first differential transistor pair constructed from the pair of emitter-coupled bipolar transistors 141 and 142 and a second differential transistor pair constructed from the pair of emitter-coupled bipolar transistors 143 and 144, and a linearizing transistor pair constructed from the pair of collector-coupled bipolar transistors 145A and 145B. The bases of the transistors 142 and 143 are coupled together. The emitter of the transistor 145A is connected to the bases of the transistors 141 and 144. On the other hand, the emitter of the transistor 145B is connected to the bases of the transistors 142 and 143.

The multiplier/divider circuit 140 is a linearized multiplier circuit in which the nonlinear components arising from the exponential characteristics of the bipolar transistors are suppressed. The multiplier core is constructed from the four transistors 141 to 144. The transistors 145A and 145B are configured to perform preprocessing for linearization.

The sum of the output current of the first V-I converter circuit 110 and one of the two output currents of the third V-I converter circuit flows into the emitter of the transistor 145A. Likewise, the sum of the inverted output current of the first V-I converter circuit 110 and the other of the two output currents of the third V-I converter circuit flows into the emitter of the transistor 145B. In this way, in the multiplier/divider circuit 140, since the addition of current signals can be accomplished by suitably wiring the connections, the output terminals of the first and third V-I converter circuits 110 and 130 are connected together so as to form an adder circuit for adding together the output currents of the first and third V-I converter circuits.

The transistors 145A and 145B are both diode-connected transistors, and their bases and collectors are connected to the negative power supply V−.

The emitters of the transistors 141 and 142 are coupled together, and the sum of the output current of the second V-I converter circuit 120 and the bias current Ib flows into the emitters. Likewise, the emitters of the transistors 143 and 144 are coupled together, and the sum of the inverted output current of the second V-I converter circuit 120 and the bias current Ib flows into the emitters. The bias current Ib is generated by the bias current source 146A, 146B which is a constant-current circuit.

The collectors of the transistors 141 and 143 are coupled together to form a multiplier output terminal. Similarly, the collectors of the transistors 142 and 144 are coupled together to form a multiplier inverted output terminal.

The I-V converter circuit 150 converts the output current signal of the multiplier/divider circuit 140 into a voltage signal. A folded cascode circuit formed by MOS transistors 151A to 154A and 151B to 154B converts the differential current input into a single-phase current signal, which is further converted by an operational amplifier 155 with a conversion resistor 156 into a voltage signal for output. The conversion resistor 156 is constructed from a linear resistive element such as a polysilicon resistor.

In the multiplier/divider circuit 140 shown in FIG. 2, if the supply current from the third V-I converter circuit 130 increases, the bias current supplied to the linearizing transistors 145A and 145B increases. If the bias current increases, the base-emitter voltage of the linearizing transistors 145A and 145B increases. In the linearizing transistors 145A and 145B, if the bias current decreases, the base-emitter voltage decreases, and the voltage change of the output signal for the input signal increases (that is, the gain is large). In this case, if the signal component from the first V-I converter circuit 110 is added, the gain of the signal component output to the multiplier core increases. Conversely, in the linearizing transistors 145A and 145B, if the bias current increases, the base-emitter voltage increases, and the voltage change of the output signal for the input signal decreases (i.e., the gain is small). In this case, if the signal component from the first V-I converter circuit 110 is added, the gain of the signal component output to the multiplier core decreases. When this relationship is seen from the output of the multiplier core, the operation is performed such that the amplitude ratio between the output signal component obtained via the multiplier core from the linearizing transistors 145A and 145B and the signal component from the first V-I converter circuit 110 is inversely proportional to the supply current from the third V-I converter circuit 130; therefore, when the output of the multiplier/divider circuit 140 is viewed as a whole, it is equivalent to dividing by the output of the third V-I converter circuit 130.

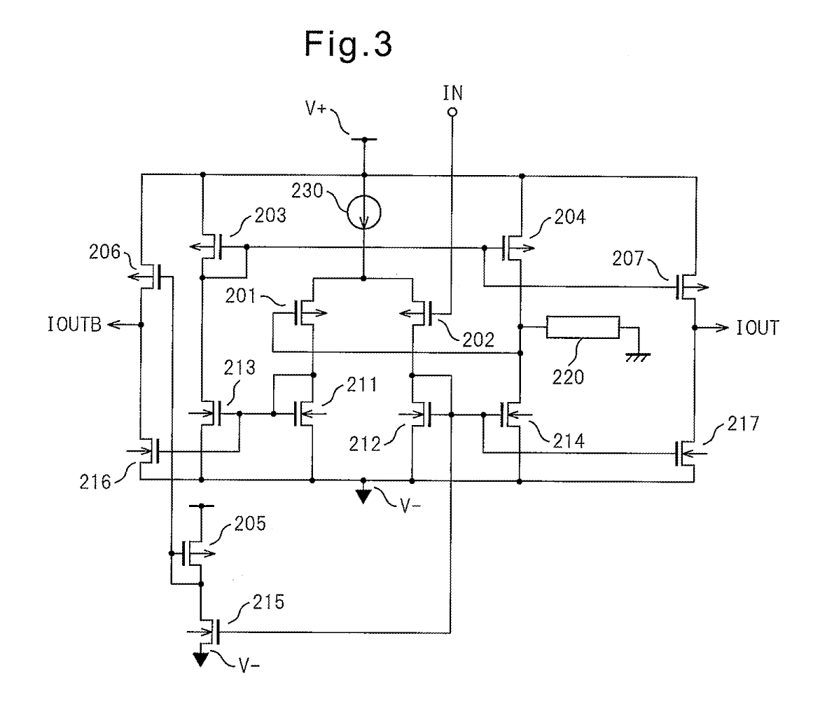

FIG. 3 is a circuit diagram illustrating the V-I converter circuit used in the physical quantity sensor.

The V-I converter circuit configuration shown in FIG. 3 is employed for each of the first and second V-I converter circuits 110 and 120.

The V-I converter circuit is a transconductance amplifier that uses MOS transistors and a resistive element, and comprises p-channel MOS transistors (PMOSs) 201 to 207, n-channel MOS transistors (NMOSs) 211 to 217, a conversion resistor 220, and a tail current source 230.

The gate terminal of the PMOS 201 is taken as an input terminal (IN) of the V-I converter circuit. When the V-I converter circuit shown in FIG. 3 is used as the first V-I converter circuit 110 shown in FIG. 2, the phase-adjusted oscillator signal S21′ is input at the input terminal (IN).

The PMOSs 201 and 202, the NMOSs 211 and 212, and the tail current source 230 together constitute a differential pair circuit with the PMOSs 201 and 202 acting as input devices and the NMOSs 211 and 212 as load devices. The gate terminal of the PMOS 201 corresponds to the noninverting input terminal of the differential pair circuit, and the gate terminal of the PMOS 202 corresponds to the inverting input terminal. The tail current source 230 supplies a bias current to the differential pair circuit.

The NMOSs 211 and 212 are diode-connected transistors, and the current flowing in the NMOS 212 is copied by a current mirror to the NMOS 214 by multiplying the current by a prescribed factor. Further, the current flowing in the NMOS 211 is copied via the NMOS 213 and PMOS 203 to the PMOS 204 by multiplying the current by a prescribed factor. The drain terminals of the PMOS 204 and NMOS 214 are connected together, and the gate terminal of the PMOS 201, which corresponds to the inverting input terminal, and one end of the conversion resistor 220 are connected to the drain terminals. The other end of the conversion resistor 220 is connected to a signal ground. The conversion resistor 220 is constructed from a linear resistive element such as a polysilicon resistor.

Further, the current flowing in the PMOS 204 is copied by a current mirror connection to the PMOS 207, and the current flowing in the NMOS 214 is copied by a current mirror connection to the NMOS 217. The drain terminals of the PMOS 207 and NMOS 217 are connected together, and this connecting node is taken as an output terminal (IOUT). When the V-I converter circuit shown in FIG. 3 is used as the first V-I converter circuit 110 shown in FIG. 2, the output current (+) is output at the output terminal (IOUT).

The current flowing in the NMOS 211 is copied by a current mirror to the NMOS 216 by multiplying the current by a prescribed factor. Further, the current flowing in the NMOS 212 is copied via the NMOS 215 and PMOS 205 to the PMOS 206 by multiplying the current by a prescribed factor. The drain terminals of the PMOS 206 and NMOS 216 are connected together, and this connecting node is taken as an inverting output terminal (IOUTB). When the V-I converter circuit shown in FIG. 3 is used as the first V-I converter circuit 110 shown in FIG. 2, the inverted output current (−) is output at the output terminal (IOUTB).

With the above connections, the PMOSs 201 to 204 and NMOSs 211 to 214 together act as a voltage follower whose output is taken at the ungrounded end of the conversion resistor 220, and a signal identical to the signal input at the input terminal IN appears at the ungrounded end of the conversion resistor 220. Further, the current flowing to the conversion resistor 220 is copied by the remaining MOS transistors, and a current whose value is equal to the input signal voltage divided by the resistance value of the conversion resistor 220 is output at the terminal IOUT. On the other hand, a current equal in magnitude but opposite in direction to the current appearing at the terminal IOUT is output at the terminal IOUTB.

When the input voltage is denoted by V, and the output current by I, the V-I converter circuit operates so that the relation defined by the following equation (3) holds.

I=±K·V (3)

In the above equation (3), when the sign is (+), I represents the output current appearing at the output terminal, and when the sign is (−), I represents the output current appearing at the inverting output terminal. The conversion coefficient K is the reciprocal of the resistance value of the conversion resistor 220.

When the V-I converter circuit shown in FIG. 3 is used as the third V-I converter circuit 130, an additional circuit for copying the currents flowing in the PMOS 207 and NMOS 217 by a current mirror connection is provided so that a current identical in value to the current output at the terminal IOUT can be output. In this case, the output current (+) is output at the output terminal (IOUT), and the identical output current (+) is output at the output terminal of the additional circuit. When the V-I converter circuit shown in FIG. 3 is used as the third V-I converter circuit 130, the output current appearing at the output terminal (IOUTB) is not used.

Next, the operation of the physical quantity sensor 1 will be described with reference to FIG. 1.

When the supply voltages V+ and V− are applied to the physical quantity sensor 1, the reference signal generating circuit 40 outputs the reference signal S41, and the oscillator circuit 20 drives the driving part 11 of the sensor device 10 with a prescribed AC current which is controlled based on the reference signal S41. Because of the AGC control, AC voltage whose amplitude is controlled based on the reference signal S41 is output as the oscillator signal S21.

In this condition, when a rotational angular velocity is applied to the physical quantity sensor 1, an AC signal having an amplitude proportional to the rotational angular velocity appears in the sensor device output S12. The detection circuit 30 amplifies and converts the sensor device output S12 into a voltage signal, and the amplified signal S31 is supplied as input to the detector circuit 32. The reference signal S41 and the oscillator signal S21 are also supplied as inputs to the detector circuit 32. The detector circuit 32 performs product detection as will be described hereinafter, and the filter circuit 33 at the subsequent stage performs processing for smoothing the output. The physical quantity sensor 1 thus outputs the detected signal S30 whose amplitude is proportional to the applied rotational angular velocity.

Next, the operation of the detector circuit 32 in the physical quantity sensor 1 will be described.

The voltage value of the oscillator signal S21 is denoted by V1, the voltage value of the amplified signal S31 by V2, and the voltage value of the reference signal S41 by Vref. Here, V1 and V2 are sinusoidal signals (expressed in the form of A·sin θ) having the same frequency and phase.

The relationship between the voltage value Vref of the reference signal S41 and the output current Ir of the third V-I converter circuit 130 can be expressed by the following equation (4).

Ir=Vref/R3 (4)

where R3 is the resistance value of the conversion resistor in the third V-I converter circuit 130.

On the other hand, the current signal 11 applied to one input of the multiplier/divider circuit 140 and the current signal 12 applied to the other input of the multiplier/divider circuit 140 are given by the following equations (5) and (6), respectively.

I1=Ib±K1·V1 (5)

I2=Ir±K2·V2 (6)

The double sign corresponds to the differential signal output.

Further, the output current I4 of the multiplier/divider circuit 140 is given by the following equation (7).

I4=((K1·K2)/Ir)·(V1·V2) (7)

When the resistance value of the conversion resistor 156 of the I-V converter circuit 150 is denoted by R5, the detected signal S32 as the output signal of the I-V converter circuit 150 is given by the following equation (8).

$$\begin{matrix}( Voltage value of detected signal S32 ) = ( 2 \cdot R 5 \cdot ( K 1 \cdot K 2 ) / Ir ) \cdot \\ ( V 1 \cdot V 2 ) \\ = ( 2 \cdot ( R 3 \cdot R 5 \cdot K 1 \cdot K 2 ) ) \cdot \\ ( V 1 \cdot V 2 / Vref )\end{matrix} \qquad ( 8 )$$

In the illustrated example, V1 in the above equation (8) corresponds to the voltage value of the oscillator signal S21. The oscillator signal S21 is a signal whose oscillation amplitude is controlled by the AGC control circuit, and depends on (is proportional to) the voltage value Vref of the reference signal S41 that serves as a reference for the AGC control.

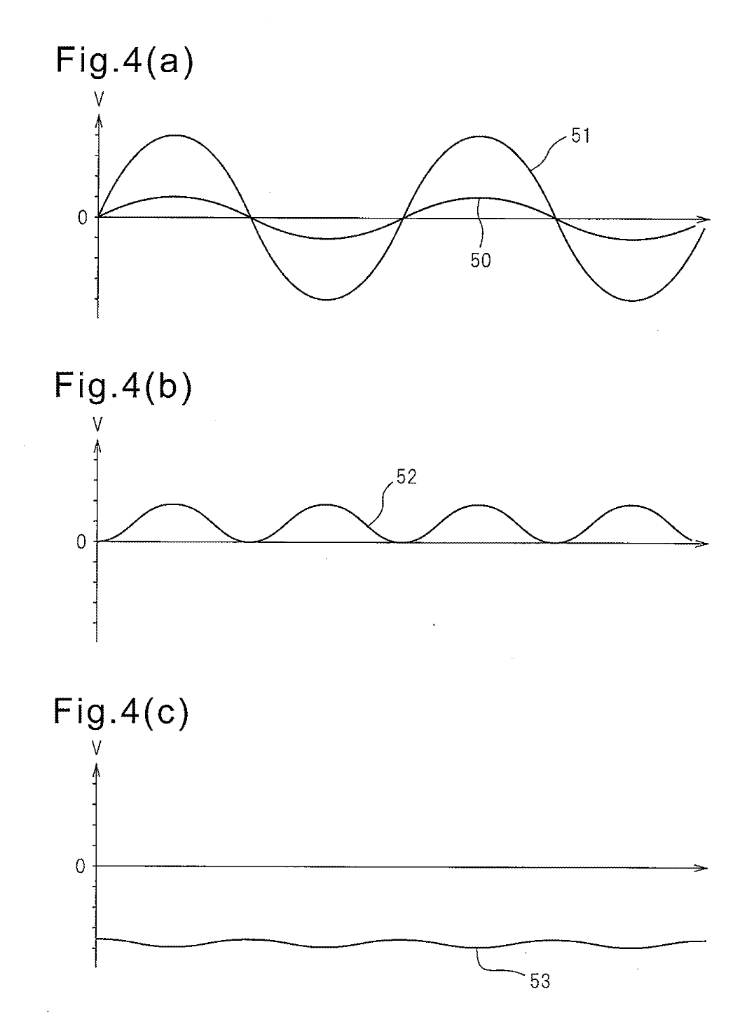

Further, in the illustrated example, V2 corresponds to the voltage value of the amplified signal S31 produced by amplifying the angular velocity signal obtained from the detection part 12. Accordingly, the amplified signal S31 is proportional to the intensity of the applied angular velocity, but it is also proportional to the intensity of the excitation applied to the driving part 11 in order to detect the angular velocity. That is, the amplified signal S31 is proportional to the voltage value Vref of the reference signal S41. Waveform 50 shown in FIG. 4(a) is an example of the waveform of the oscillator signal S21, and waveform 51 is an example of the waveform of the amplified signal S31.

Accordingly, the voltage amplitude of the detected signal, i.e., the output signal of the I-V converter circuit 150, is proportional not only to the applied angular velocity but also to the voltage value Vref of the reference signal S41. The same applies to the physical quantity sensor output S30 produced by smoothing the detected signal S32. Waveform 52 shown in FIG. 4(b) is an example of the waveform of the detected signal S32, and waveform 53 shown in FIG. 4(c) is an example of the waveform of the physical quantity sensor output S30.

That is, it can be seen that the dependence of the output S30 of the physical quantity sensor 1 on the reference signal S41 can be suppressed nearly to first order. This characteristic in itself is the same as that of the prior art physical quantity sensor using a detector circuit that performs detection by switching, but the difference is that the original signal component to be detected is only the signal component having the same frequency as the oscillator frequency, and if noise having other frequency components due to external vibrations, etc., is at all contained, such frequency components are converted to sufficiently high frequencies by the product detection, and therefore can be easily removed by the filter circuit 33 at the subsequent stage.

Accordingly, the physical quantity sensor 1 incorporating the above-described detector circuit 32 can reduce the effects that variations in the reference voltage S41 may have on the output signal S30, and can achieve high accuracy and increased resistance to noise caused by external vibrations.

K1 and K2 represent the conversion ratios of the V-I converter circuits. In the physical quantity sensor 1, if provisions are made to determine K1 and K2 based on the linear resistive elements, it is possible to compensate for variations in the temperature coefficients of R3 and K1 (or K2) or variations in semiconductor process, etc. Likewise, if the same linear resistive element is employed for the conversion resistor 155 used in the I-V converter circuit 150, it becomes possible to compensate for variations in the temperature coefficients of R5 and K2 (or K1) or variations in semiconductor process, etc.

When the values of the conversion resistors used in the first and second V-I converter circuits 110 and 120 are denoted by R1 and R2, respectively, and the value of the conversion resistor used in the third V-I converter circuit 130 is denoted by R3, the detected signal S32 can be expressed by the following equation (9).

(Voltage value of detected signal S32)=2·(R3·R5)/(R1·R2)·(V1·V2/Vref) (9)

From the above equation (9), it can be seen that errors that may occur in the V-I converter circuits and I-V converter circuit can be compensated for by employing the resistive element of the same material for each of the conversion resistors used in the first to third V-I converter circuits 110, 120, and 130 and the I-V converter circuit 150.

In the detector circuit 32 shown in FIG. 2, when adding the component of the reference signal S41 to the component of the oscillator signal S21, they are first converted by the first V-I converter circuit 110 and the third V-I converter circuit 130 into current signals, and then they are added together. However, the component of the reference signal S41 and the component of the oscillator signal S21 may be added together in the form of voltage signals, and then the sum voltage signal may be converted into a current signal. In that case, the addition of the voltage signals can be implemented using a well-known voltage adder circuit constructed from a combination of an operational amplifier and a resistive element.

In the physical quantity sensor 1 of FIG. 1, the reference signal S41 used for the AGC control has been shown as being a voltage signal. However, the circuit configuration may be such that the reference signal S41 is a current signal. In that case, the third V-I converter circuit 130 can be eliminated.

Further, the physical quantity sensor 1 of FIG. 1 has been configured so that the reference signal S41 is added to the oscillator signal S21 obtained from the driving unit 11. However, the reference signal S41 may be added to the amplified signal S31 obtained by amplifying the sensor device output S12, and the resulting sum signal and the oscillator signal S21 may be input to the current multiplier circuit. Since the order of multiplications can be interchanged if the modification is made as described above, it is apparent that the output signal S30 can likewise be obtained.

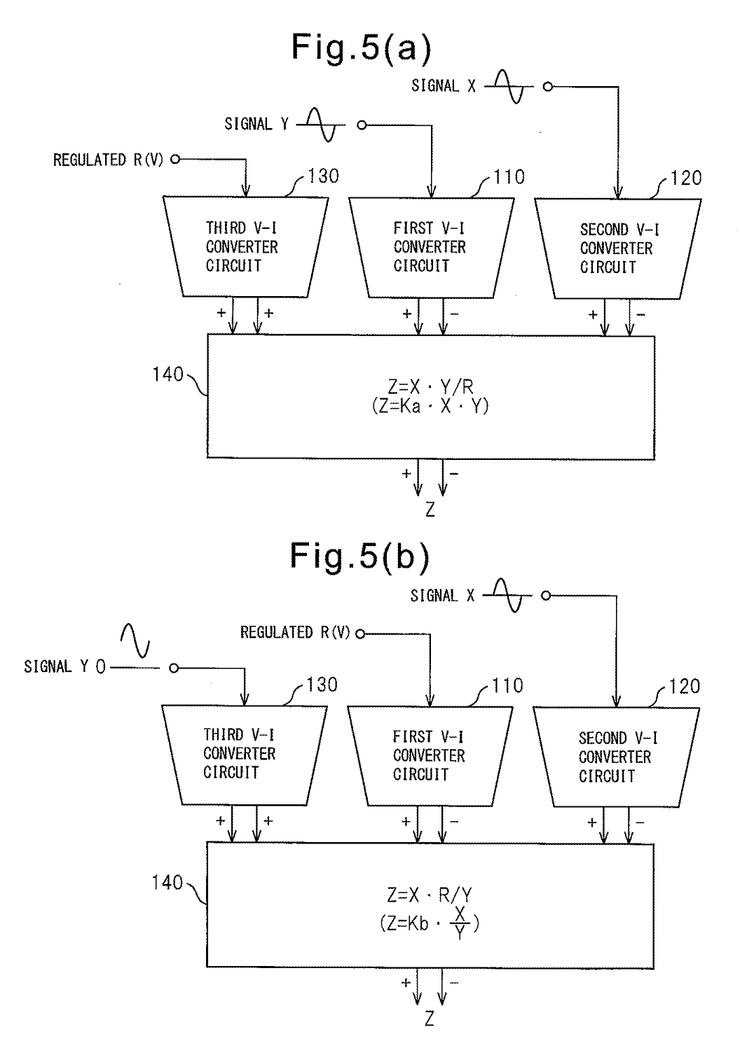

FIG. 5 is a diagram for explaining the multiplier/divider circuit 140.

FIG. 5(a) illustrates in schematic form the relationship between the multiplier/divider circuit 140 and the first to third V-I converter circuits 110 to 130.

As earlier described, the output Z of the multiplier/divider circuit 140 can be expressed as Z=X·Y/R, where Y is the voltage signal input to the first V-I converter circuit 110, X is the voltage signal input to the second V-I converter circuit 120, and R is the voltage input to the third V-I converter circuit 130. For example, suppose that the voltage R input to the third V-I converter circuit 130 is a regulated output from a generating circuit that can generate a desired voltage by using a digital volume capable of digitally varying its resistance value. In that case, it can be said that the circuit is a variable gain multiplier circuit that can regulate, without using an additional gain amplifier, the product of the two voltage signals by a factor of Ka such that the output Z of the multiplier/divider circuit 140=Ka·X·Y.

FIG. 5(b) is a diagram showing a modified example in which the inputs to the multiplier/divider circuit 140 are changed. In FIG. 5(b), the voltage R is input to the first V-I converter circuit 110, and the voltage signal Y is input to the third V-I converter circuit 130. The voltage signal Y is a positive signal.

In the case of FIG. 5(b), the output Z of the multiplier/divider circuit 140 can be expressed as Z=X·R/Y. For example, suppose that the voltage R input to the first V-I converter circuit 110 is a regulated output. In that case, it can be said that the circuit is a variable gain divider circuit that can regulate, without using an additional gain amplifier, the ratio (quotient) of the two voltage signals by a factor of Kb such that the output Z of the multiplier/divider circuit 140=Kb·X/Y.

As shown in FIGS. 5(a) and 5(b), by using the multiplier/divider circuit 140 in the detector circuit, the multiplication of the two signals and the division by the reference signal Vref can be simultaneously performed by using the same circuit.

1. A physical quantity sensor comprising:
an oscillator which converts an externally applied physical quantity into an electrical signal;
a reference signal generating circuit which outputs a reference signal;
an oscillator circuit which causes said oscillator to oscillate by applying an oscillator signal produced based on said reference signal; and
a detector circuit which detects an output signal of said oscillator by performing a multiplication of said output signal by said oscillator signal and a division by said reference signal.

2. The physical quantity sensor according to claim 1, wherein said detector circuit includes,
a multiplier core comprising a first differential transistor pair constructed from a pair of emitter-coupled bipolar transistors and a second differential transistor pair constructed from a pair of emitter-coupled bipolar transistors,
a linearizing transistor pair constructed from a pair of collector-coupled bipolar transistors, and
an adder circuit which adds said reference signal to either one of said oscillator signal and said output signal,
wherein a base of one of said bipolar transistors in said first differential transistor pair and a base of one of said bipolar transistors in said second differential transistor pair are coupled together and connected to an emitter of one of said bipolar transistors in said linearizing transistor pair,
wherein a base of the other one of said bipolar transistors in said first differential transistor pair and a base of the other one of said bipolar transistors in said second differential transistor pair are coupled together and connected to an emitter of the other one of said bipolar transistors in said linearizing transistor pair,
wherein either one of said oscillator signal and said output signal is input to said coupled emitters of said first and second differential transistor pairs, and
wherein the other one of said oscillator signal and said output signal is input to the emitters of said linearizing transistor pair.

3. The physical quantity sensor according to claim 2, wherein said detector circuit further includes a converter circuit which converts said oscillator signal, said output signal, and said reference signal respectively from voltage signals into current signals.

4. The physical quantity sensor according to claim 3, wherein said adder circuit adds either one of said oscillator signal and said output signal respectively converted into said current signals to said reference signal converted into said current signal.

5. The physical quantity sensor according to claim 2, wherein said adder circuit adds either one of said oscillator signal and said output signal to said reference signal in the form of voltage signals.

6. (canceled)
